(19) United States
(12) Patent Application Publication
(10) Pub. No.: US 2013/0216390 A1
(43) Pub. Date: Aug. 22, 2013

(54) REINFORCED COMPOSITES PRODUCED BY A VACUUM INFUSION OR PULTRUSION PROCESS

(71) Applicants: Usama Younes, McMurray, PA (US); Serkan Unal, Istanbul (TR)

(72) Inventors: Usama Younes, McMurray, PA (US); Serkan Unal, Istanbul (TR)

(73) Assignee: Bayer MaterialScience LLC, Pittsburgh, PA (US)

(21) Appl. No.: 13/400,292

(22) Filed: Feb. 20, 2012

(51) Int. Cl. F03D 1/06; C08K 3/40; B29C 70/36; B29C 55/30; B32B 5/02; C08L 75/04; C08L 33/04; B82Y 30/00

(52) U.S. Cl. 416/241 R; 524/590; 523/466; 524/556; 264/553; 264/164; 442/59; 977/752

(57) ABSTRACT

Carbon nanotube-reinforced composites are produced by incorporating up to 0.7% by weight of carbon nanotubes into a liquid polymeric material a polymeric material. The viscosity of the carbon nanotube-containing liquid polymeric is sufficiently low that it can be used in vacuum infusion and pultrusion processes to produce large articles such as wind turbine blades.

### STATEMENT REGARDING FEDERALLY SPONSORED RESEARCH

This invention was made at least in part, through research funded by the U.S. Government under contract number EE-EE0001361 awarded by the U.S. Department of Energy. The government may have certain rights in the invention.

### BACKGROUND OF THE INVENTION

The present invention relates to composites reinforced with both a fibrous material and carbon nanotubes that are produced by a vacuum infusion or pultrusion process and to the process for producing such composites from this system. The processing characteristics of the liquid polymer or polymer-forming system and the physical properties of the composites produced from such liquid polymer or polymer-forming system of the present invention are particularly advantageous for producing large articles characterized by short de-mold times, reduced shrinkage and improved fracture toughness. The composites of the present invention are particularly suitable for applications such as turbine wind blades.

Reinforced composites are being used for a number of applications where strength and light weight are important physical properties. Examples of applications for which fiber reinforced composites are employed include automotive components and construction materials.

To date, the applications for which fiber reinforced composites have been used have been limited by the processability of the polymer-forming system, the inability to achieve uniform distribution of the particulate reinforcing material, and the properties of the polymeric material used to produce the composite. More specifically, production of larger composite articles requires a liquid reactive system having a viscosity that is low enough to thoroughly penetrate the reinforcing material and a reactivity slow enough that it will not set completely before the form or mold has been completely filled but not so slow that production of a single molded composite article will require such an extremely long period of time that it becomes uneconomical to produce a composite article with that material. Inclusion of a particulate reinforcing material such as carbon nanotubes in the polymer-forming system introduces further issues with respect to uniformity of distribution of the particulate material and increased viscosity due to such particulates.

One method for increasing the speed with which a reactive system is introduced into the reinforcing material is a vacuum infusion molding process. In a vacuum infusion molding process, the reinforcing material is positioned within a vacuum chamber. The pressure within this vacuum chamber is then drawn down. The pressure differential between the bag in which the pressure has been reduced and the atmospheric pressure on the reactive mixture to be fed into the bag pushes the reactive mixture into the bag and into the reinforcing material. This technique is not, however, without its problems. Localized areas of the composite produced may exhibit less than optimum physical properties due to poor fiber volume control, lower fiber volume and excess resin. When particulate material is also included in the reactive system, additional processing problems are encountered with non-uniform distribution of the particulate material and increased viscosity of the reactive system prior to application of that reactive system to the fibrous reinforcing material. When carbon nanotubes are used as the particulate material, the agglomeration of those nanotubes is also a problem.

Attempts to resolve some of the problems encountered with the vacuum infusion process have included the use of a specially designed mold (U.S. 200810237909), use of a double vacuum chamber resin infusion device (U.S. 2008/0220112), use of multiple flow injection points, introduction of a thermoplastic material in two separate stages (U.S. 2010/0062238), and production of smaller segments of the desired article with subsequent joinder of those segments (U.S. 2007/0183888).

However, these techniques require specially designed equipment and/or multiple process steps.

Methods for including particulate materials such a carbon nanotubes in polymeric composites have been developed. In U.S. Pat. No. 7,955,654, for example, multi-walled carbon nanotubes are dispersed in an organic solvent. Monomers and an initiator are then dissolved in this dispersion. The dissolved monomers are then polymerized to form a composite which is then coated onto a PET film. The problems of uniformity of distribution, agglomeration and increased viscosity due to the inclusion of the carbon nanotubes are not, however, addressed in this method.

U.S. Pat. No. 6,936,653 discloses composite materials composed of polar polymers and single-wall carbon nanotubes characterized by electrical and/or thermal conductivity and a process for their production. In the disclosed process, single-walled carbon nanotubes are dispersed in a polar polymer in a solvent to make a nanotube-polymer suspension. The solvent is then removed from the suspension to form a nanotube-polymer composite. This method is clearly unsuitable for distribution of nanotubes in a reactive polymer-forming system. Further, use of solvent and the need to remove this solvent increase the cost of materials and equipment necessary to conduct this process. Agglomeration of the nanotubes is not a concern addressed in this disclosure.

U.S. Pat. No. 7,838,587 discloses polymeric materials containing dispersed carbon nanotubes which are produced by incorporating the nanotubes into a mixture of a polymer and a dispersant selected from specified types of block copolymers and heating this mixture while stirring. To this mixture is added a hardener and the resulting mixture is then introduced into a mold. Issues with respect to increased viscosity and uniformity of distribution and avoidance of agglomeration of the carbon nanotubes are not addressed.

U.S. Pat. No. 7,935,276 discloses polymeric materials which incorporate carbon nanostructures which are carbon nanospheres that are hollow, multi-walled particles having multiple graphitic layers, an outer diameter of less than 1 micron and no surface functional groups. These specified nanospheres were developed because incorporation of carbon nanotubes into polymeric materials was found to be “very challenging”. The fibrous shape of carbon nanotubes combined with their small size makes them difficult to uniformly disperse in polymers. (column 1, lines 38-45)

Published U.S. Patent Application 2011/0086956 discloses nanocomposite master batch compositions and a method for producing polymeric nanocomposite materials. Polymer nanocomposites are made by dissolving a polymer in a solvent to produce a polymer solution. A dispersing aid (e.g., a surfactant or compatibilizing agent) is added to this polymer solution and the filler material is then added to produce a dissolved polymer intimately mixed with the nanocomposite material. This mixture is then treated (e.g., by addition of a non-solvent liquid) to cause the precipitation of the dissolved composite solution to produce a nanocomposite master batch. This nanocomposite master batch may then be used in its highly concentrated state or further compounded with additional polymer material. The method disclosed in this publication does not, however, address the issues presented when carbon nanotubes are used as the nanomaterial filler, particularly, increased viscosity.

Published U.S. Patent Application 2011/0171364 discloses a process for the production of carbon nanotube-based pastes in which carbon nanotubes are milled to disperse them in a liquid to form the paste. Such nanotube-containing pastes are then used to produce battery electrodes. The pastes disclosed in this publication would not, however, be suitable for use in applications where low viscosity of the nanotube-containing composition is essential such as the production of large composites by a vacuum infusion or a pultrusion process.

Published U.S. Patent Application 2011/0245378 discloses nanomaterial-reinforced compositions and methods for their production and use. In the processes disclosed in this publication, carbon nanotubes are dispersed in a resin by contacting the carbon nanotubes with the resin. In one embodiment of the published process, the reinforcement material (e.g., carbon nanotubes) are combined with a first solvent and then dispersed in the solvent by any of a variety of methods, including, mixing, sonication, and shaking. After being dispersed in the first solvent, the reinforcement material may be mixed with the resin which is subsequently cured. Issues such as increased viscosity due to inclusion of the nanomaterials and maintenance of an even distribution of the carbon nanotubes are not addressed in this publication.

Incorporation of carbon nanotubes in a liquid polymer-forming reaction mixture, especially a polyurethane-forming reaction mixture, to be used in a vacuum infusion or pultrusion process capable of producing large composite articles with consistently good physical and mechanical properties has not yet been achieved.

It would, therefore, be advantageous to develop a low viscosity, polymer-forming system which includes uniformly dispersed carbon nanotubes that can be successfully infused into a fibrous reinforcing material such as glass fibers before the polymer-forming reaction has been completed and also has a reactivity that is not so slow that production of the composite becomes economically impractical.

### SUMMARY OF THE INVENTION

It is an object of the present invention to provide a carbon nanotube-reinforced liquid polymer or polymer-forming system for the production of large composite articles.

It is also an object of the present invention to provide a carbon nanotube-reinforced liquid polymer or polymer-forming system that can be effectively incorporated into a fibrous reinforcing material by a vacuum infusion process or by a pultrusion process.

It is another object of the present invention to provide a carbon nanotube-reinforced epoxy resin or polyurethane-forming system that can be effectively incorporated into a fibrous reinforcing material by a vacuum infusion process or by a pultrusion process.

It is a further object of the present invention to provide a carbon nanotube-reinforced composite article produced with the carbon nanotube-reinforced liquid polymer or polymer-forming system of the present invention.

It is also an object of the present invention to provide a carbon nanotube-reinforced composite article produced with a liquid epoxy resin or polyurethane-forming system of the present invention.

It is another object of the present invention to provide a carbon nanotube-reinforced liquid polymer or polymer-forming system for the production of a composite wind turbine blade.

It is also an object of the present invention to provide a process for vacuum infusion of a reinforcing material with the carbon nanotube-containing liquid polymer or polymer-forming system of the present invention.

It is an additional object of the present invention to provide carbon nanotube-reinforced composites produced by a vacuum infusion process that have sufficient green strength to be de-molded in 6 hours or less and have a significantly improved fracture toughness.

These and other objects which will be apparent to those skilled in the art are accomplished by incorporating a liquid, polymer or polymer-forming system that (a) contains sufficient carbon nanotubes that from 0.05 to 0.7% by weight (based on total weight of the polymer-forming system plus weight of nanotubes) of carbon nanotubes will be present in the total polymer-forming system and which carbon nanotubes are uniformly dispersed in the liquid polymer or polymer-forming system, (b) has a viscosity at 25° C. of less than 1000 mPas for at least 30 minutes, (c) has a gel time of greater than 90 minutes and (d) has a water content of less than 0.06% by weight into a fibrous material, preferably glass fiber, and curing that liquid polymer or polymer-forming system to form a fibrous, carbon nanotube reinforced composite article.

### DETAILED DESCRIPTION OF THE PRESENT INVENTION

The present invention is directed to a liquid polymer or polyurethane-forming system which even after incorporating up to 0.7% by weight, preferably, up to 0.5% by weight of carbon nanotubes has a viscosity at 25° C. sufficiently low that it can be used to produce large fiber-reinforced composites by a vacuum infusion process or by a pultrusion process or any other known process where a low viscosity polymer or polymer-forming system is required. As used herein, the expression “low viscosity” means that the carbon nanotube-containing polymer or polymer-forming system has a viscosity of less than 1000 mPas for at least 30 minutes, preferably less than 600 mPas, most preferably, from 200 to 400 mPas. The carbon nanotube-reinforced liquid polymer or polymer-forming systems of the present invention will also generally have a gel time of greater than 90 minutes, preferably, greater than 120 minutes. A water content of less than 0.1% by weight, preferably, less than 0.05% by weight, based on the total weight of the liquid polymer or polymer-forming system is also required.

Any of the known, commercially available carbon nanotubes may be incorporated into the liquid polymer or polymer-forming systems of the present invention. Multiwall carbon nanotubes and functionalized carbon nanotubes are generally preferred for economic reasons but other types of nanotubes may also be used. Multiwall carbon nanotubes are commercially available under the names Baytubes C150 and Baytubes C70 from Bayer MaterialScience. Functionalized carbon nanotubes are those having functional groups such as amine or hydroxyl groups on their surface.

The use of carbon nanotubes is problematic in that uniform dispersion of the nanotubes must be achieved in order to attain product consistency and to avoid the creation of segments within the composite product that have poorer properties than other segments of that composite product. Use of carbon nanotubes also presents the problem of the formation of agglomerates after those nanotubes have been dispersed which agglomerates will adversely affect the properties of the composite product.

In one method that has been found to achieve uniform distribution of carbon nanotubes, particularly, multi wall carbon nanotubes, within a liquid polymer or polymer-forming system, (a) a liquid component of a polymer-forming system or a liquid polymer-forming system, (b) a dispersing aid, (c) up to 10% by weight, preferably, from 0.05 to 6% by weight, most preferably, from 1 to 4% by weight, of carbon nanotubes and (d) if necessary, a viscosity reducing agent are mixed in a high shear mixer for at least 2 hours, preferably, from 2 to 7 hours, more preferably, from 3 to 5 hours, most preferably, about 5 hours to produce a master batch. This master batch is then diluted to the desired viscosity and to a carbon nanotube content such that the final polymer-forming composition will contain up to 0.7% by weight of carbon nanotubes (based on total weight of polymer-forming system plus nanotubes), treated to break up any agglomerates of carbon nanotubes present in that master batch and then filtered to remove any remaining agglomeration of carbon nanotubes greater than 5 μm, preferably, greater than 2.5 μm in size.

In addition to high shear mixing, other techniques suitable for mixing components (a) through (d) include: sonication and ball milling.

Suitable treatments for breaking up any carbon nanotube agglomerates include sonication and ball milling.

Any liquid polymer or polymer-forming system or component of a polymer-forming system having a viscosity of less than 1000 centipoise may be reinforced with carbon nanotubes in accordance with the present invention. Examples of suitable liquid polymers, components of polymer-forming systems and polymer-forming systems that may be used in the practice of the present invention include epoxy resins, vinyl ester resins and polyurethane-forming systems and components. Polyurethane-forming systems and the components of such systems are particularly preferred.

Polyurethane-forming systems include an isocyanate component and an isocyanate-reactive component.

A particularly preferred isocyanate component of a polyurethane-forming system suitable for use in the present invention has a viscosity at 25° C. of from about 20 to about 300 mPas, preferably, from about 20 to about 300 mPas, more preferably, less than 100 mPas, most preferably, from about 40 to about 80 mPas. This isocyanate component includes at least one diisocyanate or polyisocyanate.

The isocyanate-reactive component of the system of the polyurethane-forming system that is particularly preferred for use in the present invention includes: (i) one or more polyols having a viscosity(ies) at 25° C. of from 20 to 850 mPas, preferably, from about 30 to about 750 mPas, more preferably, from about 40 to about 700 mPas, most preferably, from about 50 to about 650 mPas, and an OH number of from about 200 to about 800 mg KOH/g, preferably, from about 300 to about 700 mg KOH/g, more preferably, from about 400 to about 600, most preferably, from about 350 to about 520 mg KOH/g; (ii) up to about 6% by weight, based on total isocyanate-reactive component, preferably, up to about 4% by weight, most preferably, up to about 3% by weight, of a flow additive, and (iii) from about 2 to about 6% by weight, based on total isocyanate-reactive component, preferably, from about 2 to about 4% by weight, most preferably, from about 2 to about 3% by weight of a drying agent, with the sum of the weight percents for all of the components of the isocyanate-reactive component being equal to 100% by weight.

The isocyanate-reactive component of the present invention will generally have an average functionality of from about 2 to about 6, preferably, from about 2 to about 4, most preferably, from about 2 to about 3.

Optionally, up to 1% by weight of additives which do not cause foaming may also be included in the system of the present invention, preferably, in the isocyanate-reactive component.

The isocyanate component and the isocyanate-reactive component are reacted in amounts such that the NCO Index (i.e., the ratio of the total number of reactive isocyanate groups present to the total number of isocyanate-reactive groups that can react with the isocyanate under the conditions employed in the process multiplied by 100) is from 99 to 110, preferably from about 100 to about 105, most preferably, about 102.

Any of the known diisocyanates or polyisocyanates having a viscosity no greater than 300 mPas at 25° C. or which when combined with other diisocyanates or polyisocyanates will result in an average viscosity no greater than 300 mPas at 25° C. may be included in the polyisocyanate component of the system of the present invention. It is preferred, however, that only one diisocyanate or polyisocyanate be included in the isocyanate component of the present invention. Diphenylmethane diisocyanate (MDI) and polymeric MDI are particularly preferred. An Example of a particularly preferred polyisocyanate is that which is commercially available from Bayer MaterialScience LLC under the names Mondur C D, Mondur MRS-4 and Mondur MRS-5.

Any of the known polyols having a viscosity at 25° C. of less than 850 mPas and an OH number of from about 200 to about 800 would be a suitable polyol component of the system of the present invention. Suitable polyols include polyether polyols and polyester polyols. Preferred polyols are polyether polyols having a viscosity at 25° C. of less than 850 mPas and an OH number of from about 200 to about 800. Examples of the preferred polyols are those polyether polyols which are commercially available under the names Multranol 9168, Multranol 9138, Multranol 4012, Multranol,4035, Multranol 9158, Multranol 9198, Multranol 9170, Arcol PPG425, Arcol 700, and Arcol LHT 240.

Any of the known flow additives may be included in the isocyanate-reactive component of the system of the present invention. Examples of preferred flow additives include those which are commercially available under the names Byk 1790, Byk 9076, Foamex N, BYK A530, BYK 515, BYK-A 560, BYK C-8000, BYK 054, BYK 067A, BYK 088 and Momentive L1920.

Any of the known drying agents may be included in the isocyanate-reactive component of the system of the present invention. Examples of suitable drying agents include: that which is commercially available under the name Incozol, p-toluenesulfonyl isocyanate available from the OMG Group, powdered sieves, and calcium hydride.

The reaction mixture may optionally contain a catalyst for one or more of the polymer forming reactions of polyisocyanates. Catalyst(s), where used, is/are preferably introduced into the reaction mixture by pre-mixing with the isocyanate-reactive component. Catalysts for the polymer forming reactions of organic polyisocyanates are well known to those skilled in the art. Preferred catalysts include, but are not limited to, tertiary amines, tertiary amine acid salts, organic metal salts, covalently bound organometallic compounds, and combinations thereof. The levels of the preferred catalysts required to achieve the needed reactivity profile will vary with the composition of the formulation and must be optimized for each reaction system (formulation). Such optimization would be well understood by persons of ordinary skill in the art. The catalysts preferably have at least some degree of solubility in the isocyanate-reactive component used, and are most preferably fully soluble in that component at the use levels required.

The polyurethane formulation may contain other optional additives, if desired. Examples of additional optional additives include particulate or short fiber fillers, internal mold release agents, fire retardants, smoke suppressants, dyes, pigments, antistatic agents, antioxidants, UV stabilizers, minor amounts of viscosity reducing inert diluents, combinations of these, and any other known additives from the art. In some embodiments of the present invention, the additives or portions thereof may be provided to the fibers, such as by coating the fibers with the additive.

Other optional additives include moisture scavengers, such as molecular sieves; defoamers, such as polydimethylsiloxanes; coupling agents, such as the mono-oxirane or organo-amine functional trialkoxysilanes; combinations of these and the like. Fire retardants are sometimes desirable as additives in composites. Examples of preferred fire retardant types include, but are not limited to, triaryl phosphates; trialkyl phosphates, especially those bearing halogens; melamine (as filler); melamine resins (in minor amounts); halogenated paraffins and combinations thereof.

Dispersing aids which may be included in the master batch include any material having lyophilic and lyophobic characteristics such as block copolymers. Examples of suitable dispersing aids that are commercially available include those which are commercially available under the names BYK 2155, BYK 9076 and BYK 9077. A particularly preferred dispersing aid is that which is commercially available under the name BYK 9077.

The dispersing aid is generally included in the master batch in an amount of from 1 to 10% by weight (based on the weight of the carbon nanotubes), preferably, from about 2 to about 8% by weight, most preferably, from about 3 to about 6% by weight.

Viscosity reducers which may be included in the master batch are known to those skilled in the art. Examples of suitable viscosity reducers include those which are commercially available under the names BYK W-969 BYK W-980, BYK W-985 and Vico BYK-4015. A particularly preferred viscosity reducer is that which is commercially available under the name BYK W-969. When used, the viscosity reducer is used in an amount sufficient to achieve the desired viscosity. Determination of the “appropriate” amount of viscosity reducer is within the ordinary skill of those in the art. When used, the viscosity reducer is generally used in an amount of from about 1 to about 10% by weight, based on total weight of the master batch.

The present invention also relates to fiber reinforced composites produced with a carbon nanotube dispersion of the type described in detail above. These reinforced composites may be produced by any of the known processes for producing composites in which a liquid polymer or polymer-forming system is incorporated into a fibrous material. Vacuum infusion and pultrusion are examples of suitable processes.

In a vacuum infusion process, the liquid, carbon nanotube-containing polymer or polymer-forming system is infused into a fibrous reinforcing material and subsequently cured to produce an infused reinforced material.

Suitable fibrous reinforcing materials suitable for the production of such composites include: any fibrous material or materials that can provide long fibers capable of being at least partially wetted by the polyurethane formulation during impregnation. The fibrous reinforcing material may be single strands, braided strands, woven or non-woven mat structures and combinations thereof. Mats or veils made of long fibers may be used, in single ply or multi-ply structures. Suitable fibrous materials are known. Examples of suitable fibrous materials include: glass fibers, glass mats, carbon fibers, polyester fibers, natural fibers, aramid fibers, nylon fibers, basalt fibers, and combinations thereof. Particularly preferred in the present invention are long glass fibers. The reinforcing fibers may optionally be pre-treated with sizing agents or adhesion promoters known to those skilled in the art.

The weight percentage of the long fiber reinforcement in the composites of the present invention may vary considerably, depending on the fiber type used and on the end use application intended for the composite articles.

Reinforcement loadings may be from 30 to 80% by weight of glass, preferably from 40 to 75% by weight of the final composite, more preferably from 50 to 72% by weight, and most preferably from 55 to 70% by weight, based on the weight of the final composite. The long fiber reinforcement may be present in the composites of the present invention in an amount ranging between any combination of these values, inclusive of the recited values.

The composites of the present invention are characterized by improved fatigue tensile strengths (determined in accordance with ASTM E647-05) and improved inter-laminar fracture toughness values (determined in accordance with ASTM D5528). These characteristics make the composites of the present invention particularly useful for applications such as wind turbine blades.

The composites of the present invention made with a carbon nanotube-reinforced polyurethane-forming system are characterized by faster infusion times, superior tensile fatigue, superior interlaminar fracture toughness and superior fatigue crack growth.

The composites of the present invention are preferably made by a vacuum infusion process. Vacuum infusion processes are known to those skilled in the art.

In a particularly preferred embodiment of a vacuum infusion process for production of the composites of the present invention, the carbon nanotube-containing isocyanate-reactive component and the isocyanate are de-gassed and combined to form the reaction mixture. The fibrous reinforcing material is placed in a vacuum chamber (typically, one or more bags). The pressure within this vacuum chamber is then drawn down. The pressure differential between the vacuum chamber in which the pressure has been reduced and the atmospheric pressure on the reaction mixture pushes the reaction mixture into the vacuum chamber and into the fibrous reinforcing material. The reaction mixture is cured and the composite thus formed is removed from the vacuum chamber.

It is, of course, possible to incorporate the carbon nanotubes into the isocyanate component of the polyurethane-forming system to form the carbon nanotube containing master batch in which the carbon nanotubes are uniformly dispersed. In this embodiment of the present invention, the isocyanate-reactive component and the carbon nanotube-containing isocyanate components are de-gassed and combined to form the reaction mixture. This reaction mixture is then pushed into a vacuum chamber in which the pressure has been reduced and into the fibrous reinforcing material.

A more detailed description of a vacuum infusion process can be found in Published U.S. Patent Applications 2008/0220112 and 2008/0237909.

In a pultrusion process, the fibrous reinforcing material is passed through a “bath” composed of the liquid polymer containing the uniformly dispersed carbon nanotube or of a carbon nanotube-containing polymer-forming mixture in a manner such that the fibrous reinforcing material is impregnated with the carbon nanotube-containing liquid polymer or liquid polymer forming reaction mixture. Excess polymer or polymer-forming reaction mixture is removed from the fibrous material before the remaining polymer or polymer-forming reaction mixture is cured within the impregnated fibrous material

A more detailed description of a pultrusion process can be found in the article entitled “Pultrusion of Fast Gel Thermoset Polyurethane: Processing Considerations and Mechanical Properties” from Composites 2003 Convention and Trade Show (October 2003) and in U.S. Pat. No. 5,935,508.

Having thus described the invention, the following Examples are given as being illustrative thereof. All parts and percentages reported in these Examples are parts by weight or percentages by weight, unless otherwise indicated.

### EXAMPLES

The materials used in the Examples which follow were:
EPOXY: The reaction product of 100 parts by weight of the epoxy which is commercially available under the name Hexion Epikote 135i epoxy with 30 parts of the hardener designated Hexion Epi Kure.
V-ESTER: The reaction product of 100 parts by weight of Dion 9102-75 vinyl ester and 1.5 parts by weight of Syrgis Norox CHP curing agent.
POLYURETHANE: The reaction product of 100 parts by weight of POLYOL COMPONENT with 90 parts by weight of ISOCYANATE.
POLYOL COMPONENT: 80 parts by weight of POLYOL A and 20 parts by weight of POLYOL B.
POLYOL A: A polyether polyol having a viscosity at 25° C. of approximately 650 mPas, a functionality of 3 and an OH number of approximately 370 mg KOH/g which is commercially available from Bayer MaterialScience LLC under the name Multranol 4012.
POLYOL B: A polypropylene oxide-based diol having a viscosity at 25° C. of approximately 55 mPas and an OH number of approximately 515 mg KOH/g which is commercially available from Bayer MaterialScience LLC under the name Multranol 9198.
FLOW ADDITIVE A:Silicone-free material commercially available from BYK under the designation BYK-A 560.
FLOW ADDITIVE B:Silicone-free material commercially available from BYK under the designation BYK-A 1790.
ISOCYANATE: Polymeric MDI having a viscosity at 25° C. of 40 mPas which is commercially available from Bayer MaterialScience LLC under the name Mondur MRS-4.
MWCNT Multiwall carbon nanotubes which are commercially available under the name Baytubes from Bayer MaterialScience LLC.
AMWCNT: Multiwall carbon nanotubes with amine functional groups prepared from MWCNT.

### Procedure Used to Produce the Dispersion of MWCNT's in Epoxy Used in the Examples:

An EPOXY master batch containing 1.39 wt. % MWCNT's and 13.9% by weight DISPERSING AID and 84.7% by weight of EPOXY were dispersed using a high shear mixer (Ross Mega Shear Mixer) for 5 hours to produce a master batch. This master batch was then diluted to the desired concentration stirred and sonicated to break up agglomerates and then filtered by passing the dispersion through 3 different filtration stages conducted at 4-8 psi air pressure to remove aggregates of MWCNT.

### II. Procedure Used to Produce Dispersion of MWCNT's in Polyol Component Used to Produce Polyurethane in Examples:

3 wt. % MWCNT were dispersed in 94 wt. % of POLYOL using a Ross Mega Shear Mixer for 5 hours at 14400 RPM to produce a polyol dispersion. To this polyol dispersion, 3 wt. % of the dispersant Mowital was
added and the resulting mixture was then diluted to the desired concentration,
stirred and sonicated to break up agglomerates and then filtered by passing the
dispersion through 3 different filtration stages conducted at 4-8 psi air pressure. This master batch was then combined with POLYISOCYANATE in a ratio
of 100 parts by weight POLYOL master batch to 90 parts by weight POLYISOCYANATE.

### III. Production of Composites

General Procedure:

Thin, flat plaque infusion panels were prepared from EPOXY, POLYURETHANE and V-ESTER systems. The reinforcement package was made up of either 4 or 6 plies of glass fiber fabric (Vectorply E-BX-2400-5), 810 g/m², ±45 degree bias E-glass fabric cut to a 610 mm×610 mm size. A 610 mm×610 mm ply of Airtech flow media was placed on top of each reinforcement stack. Each reinforcement package was then double bagged with 3-mil nylon film on a glass plate with an edge resin in part and a center vacuum port. A vacuum of from 2 to 60 mbars at room temperature was drawn on each reinforcement package.

The resin system being evaluated was degassed for 5 minutes at 23° C. under 70 millibars vacuum prior to infusion. After panel infusion by each resin system was complete, the resin inlet port and the vacuum port were clamped off and the resin infused panel was heated to 70° C. and held at that temperature for 1 hour. Each panel was cooled to room temperature, the bagging was removed, and each panel was postcured for 6 hours at 80° C.

For EPOXY systems, it was found that addition of small amounts of MWCNT's significantly improved the fatigue performance of composites made with EPOXY.

For VINYL-ESTER systems, it was found that improved ductility and toughness were achieved with concentrations of MWCNT as low as 0.1 wt. % MWCNT.

For POLYURETHANE, an increase of 38% in the tensile energy to break was achieved. The fatigue life in the high-stress amplitude, low-cycle regime increased by up to 248%.

The results of tests conducted to determine the interlaminar fracture toughness of the composites made with EPOXY, EPOXY with 0.38% by weight MWCNT, POLYURETHANE, POLYURETHANE into which 0.38% by weight MWCNT and POLYURETHANE into which 0.38% by weight AMWCNT had been incorporated are reported in TABLE 1 below.

TABLE 1

| | G1C (J/m2), | STANDARD |
|---|---|---|
| SAMPLE | Average | DEVIATION |
| EPOXY | 1918 | 507 |
| EPOXY with 0.38% | 2528 | 194 |
| MWCNT | | |
| POLYURETHANE | 3798 | 728 |
| POLYURETHANE | 5617 | 1273 |
| with 0.38% MWCNT | | |
| POLYURETHANE | 4222 | 800 |
| with 0.38% | | |
| AMWCNT | | |

The Fatigue Tensile testing results reported in TABLE 2 below were obtained by preparing composite laminates using 6 plies of biax glass fabric commercially available under the name VectorPly E-BX-2400, 800 g/m with each of the following: (1) POLYURETHANE with 0.38% by weight MWCNT; (2) POLYURETHANE with 0.38% by weight AMWCNT; (3) EPOXY with 0.38% by weight MWCNT; (4) POLYURETHANE; and (5) EPOXY. The tests were performed at 45° to the fiber direction. Dog-bone test samples were 8 inches long×1.125 inches wide×1.0 inch gage length with a 0.25 inch hole drilled in the middle of each bar. The test specimens were loaded axially in tension at a rate of 3 Hz. The tests were continued until the specimen had been subjected to 1 million cycles or until the specimen failed.

TABLE 2

| TEST SAMPLE | PEAK STRESS (psi) | # OF CYCLES |
|---|---|---|
| (1) | 12,000 | 15,109 |
| (1) | 11,000 | 61,656 |
| (1) | 10,000 | 255,593 |
| (1) | 9,000 | 1,000,000 |
| (2) | 12,000 | 67,802 |
| (2) | 11,000 | 506,344 |
| (2) | 10,000 | 711,266 |
| (2) | 9,000 | 1,000,000 |
| (3) | 11,000 | 74,060 |
| (3) | 10,000 | 129,775 |
| (3) | 9,000 | 677,085 |
| (3) | 8,000 | 1,000,000 |
| (4) | 13,000 | 22,372 |
| (4) | 12,000 | 44,594 |
| (4) | 11,000 | 387,418 |
| (4) | 10,000 | 849,881 |
| (5) | 12,000 | 25,999 |
| (5) | 10,000 | 93,216 |
| (5) | 9,000 | 1,000,000 |
| (5) | 8,000 | 1,000,000 |

The EPOXY, EPOXY with 0.38% by weight MWCNT, POLYURETHANE, POLYURETHANE with 0.38% by weight MWCNT and POLYURETHANE with 0.38% by weight AMWCNT samples prepared above were also subjected to fatigue testing. Some deterioration of tensile properties was observed as can be seen from the results reported in TABLE 3.

| | ULTI- | | | |
|---|---|---|---|---|
| | MATE | | APPARENT | |
| | STRESS | STANDARD | MODULUS | STANDARD |
| SAMPLE | MPa | DEVIATION | GPa | DEVIATION |
| EPOXY | 133.3 | 3.8 | 17.93 | 1.39 |
| EPOXY with | 138.5 | 1.4 | 15.31 | 1.79 |
| 0.38% | | | | |
| MWCNT | | | | |
| POLY- | 155.3 | 2.6 | 18.76 | 4.32 |
| URETHANE | | | | |
| POLY- | 130.7 | 10.1 | 14.99 | 0.89 |
| URETHANE | | | | |
| with 0.38% | | | | |
| MWCNT | | | | |
| POLY- | 150.5 | 2.6 | 14.92 | 1.09 |
| URETHANE | | | | |
| with 0.38% | | | | |
| AMWCNT | | | | |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A process for the production of a carbon nanotube reinforced composite from a polymeric binder and a fibrous material comprising:
(a) producing a carbon nanotube containing dispersion containing from 0.05 to 0.7% by weight, based on total weight of the polymeric binder comprising
(i) a liquid resin,
(ii) a dispersing aid,
(iii) up to 10% by weight, based on total weight of resin, of carbon nanotubes,
(iv) optionally, a viscosity reducer, and
(v) optionally, one or more processing aids by a process comprising:
(1) mixing the combined components (i) (v) in a high shear mixer for at least 5 hours to produce a master batch,
(2) optionally, diluting the master batch to a desired viscosity,
(3) treating the master batch or the diluted master batch to break up any agglomerates of carbon nanotubes, and
(4) filtering the treated master batch from step d) to remove any agglomeration of carbon nanotubes greater than 5 μm in size,
(b) combining the dispersion produced in (a) with any other component necessary to produce the polymeric binder to form a reaction mixture,
(c) incorporating the carbon nanotube containing dispersion or reaction mixture from (b) into a fibrous material, and
(d) subjecting the fibrous material from (c) to conditions such that the polymeric binder cures.

2. The process of claim 1 in which the polymeric binder is a polyurethane.

3. The process of claim 1 in which the polymeric binder is an epoxy resin,

4. The process of claim 1 in which the polymeric binder is a vinyl ester.

5. The process of claim 1 in which the fibrous material is selected from the group consisting of glass fibers, glass mats, carbon fibers, polyester fibers, natural fibers, aramid fibers, nylon fibers, basalt fibers, and combinations thereof.

6. The process of claim 1 in which the fibrous material is glass fiber,

7. The process of claim 1 in which step (c) is carried out by a vacuum infusion process.

8. The process of claim 1 in which step (c) is carried out by a pultrusion process.

9. The process of claim 1 in which agglomerated carbon nanotubes greater in size than 2.5 μm are removed in (a) (4).

10. The process of claim 1 in which the carbon nanotubes are multi wall carbon nanotubes.

11. The process of claim 1 in which the carbon nanotubes are first dispersed in a component of the polymeric binder-forming mixture.

12. The process of claim 1 in which the resin into which the carbon nanotubes are dispersed is a polyol.

13. The process of claim 1 in which the resin into which the carbon nanotubes are dispersed is a polyisocyanate.

14. The composite produced by the process of claim 1.

15. The composite produced by the process of claim 2.

16. The composite produced by the process of claim 7,

17. A wind turbine blade produced from the composite of claim 14.
